(19) United States
(12) Patent Application Publication
(10) Pub. No.: US 2013/0108097 A1
(43) Pub. Date: May 2, 2013

(54) MEMBRANE FOR COVERING AN OPENING IN A HEARING AID AND METHOD OF MAKING THE MEMBRANE

(71) Applicant: SIEMENS MEDICAL INSTRUMENTS PTE. LTD., SINGAPORE (SG)

(72) Inventors: CHARLES PAUL JAMES NEILSON, BAYFORD (GB); CLAUS RUDOLPH, RUEGLAND (DE); JOSEPH SAUER, STRULLENDORF (DE)

(73) Assignee: SIEMENS MEDICAL INSTRUMENTS PTE. LTD., SINGAPORE (SG)

(21) Appl. No.: 13/662,677

(22) Filed: Oct. 29, 2012

(30) Foreign Application Priority Data
Oct. 31, 2011 (DE) 10 2011 085 511.4

(51) Int. Cl. H04R 25/00; B32B 5/16; B32B 3/06; D04H 13/00

(52) U.S. Cl. 381/322; 442/327; 428/220; 428/99; 264/465

(57) ABSTRACT

A membrane for covering an opening in a hearing aid is produced by a process of electrospinning fibers to form a non-woven structure. The electrospinning is adjusted in such a way that the various requirements of the membrane are fulfilled in the hearing aid, in particular with respect to water and dirt-repelling properties and acoustic permeability. The membrane is fixed by way of example in the form of a covering, in which the membrane is held by a holding frame, by a fixing device in front of the opening in the hearing aid. The membrane is adapted by way of example so as to be permeable to sound in order to use it for covering a noise admittance or exit opening of the hearing aid.

### CROSS-REFERENCE TO RELATED APPLICATION

This application claims the priority, under 35 U.S.C. §119, of German application DE 10 2011 085 511.4, filed Oct. 31, 2011; the prior application is herewith incorporated by reference in its entirety.

### BACKGROUND OF THE INVENTION

### Field of the Invention

This invention relates to a membrane for covering an opening in a hearing aid, a covering of an opening in a hearing aid and a method for producing a membrane for covering an opening in a hearing aid.

Hearing aids usually contain a large number of openings which are susceptible to penetration of water and dirt. Examples of such openings are a microphone opening, a receiver opening, an opening for a switch element or an opening for ventilating a battery.

Various types of hearing aids are known in which parts of the hearing aid are arranged behind the ear, in the ear or in the auditory canal. As a result of this use close to the body, hearing aids are exposed to e.g. sweat or—in particular in the auditory canal—cerumen, i.e. earwax. If moisture penetrates into the hearing aid it may lead to corrosion and consequently to malfunctions and defects. In particular the acoustic openings for the microphone and the receiver may become blocked by cerumen. Cerumen which penetrates into the hearing aid can similarly lead to defects.

Due to miniaturization of the hearing aids the openings are becoming ever smaller and can consequently become blocked even by relatively small quantities of external dirt and cerumen. The dirt and cerumen accumulate during the period of use, so blocking of the openings is initially easily overlooked by the user.

A microporous membrane is known from European patent EP 0310866 B1, corresponding to U.S. Pat. No. 4,987,597, which is attached in front of a noise exit opening of a hearing aid to protect against cerumen and moisture, the membrane being made by way of example from polytetrafluorethylene (PTFE). Quenched polytetrafluorethylene, also called expanded PTFE (ePTFE), is known by the trade name Gore-Tex®.

### SUMMARY OF THE INVENTION

It is accordingly an object of the invention to provide a membrane for covering an opening in a hearing aid and a method of making the membrane which overcome the above-mentioned disadvantages of the prior art methods and devices of this general type, which provides improve protection against penetration of moisture and dirt into an opening of a hearing aid.

By way of electrostatic spinning, electrospinning for short, it is possible to produce a membrane having a structure made from non-woven micro-fibers or nanofibers which is water and dirt-repellent. The use of such a membrane for covering an opening in a hearing aid offers protection against penetration of moisture and dirt into the hearing aid.

In one embodiment of the invention the membrane is produced from a polylactic acid, also called polylactide or PLA for the common English technical term “polylactic acid”. A polymer of this kind as a starting material allows electrospinning to be easily carried out. The counterclockwise L-form of polylactide, also called PLLA for the common English technical term “poly(L-lactide) acid”, is preferably used.

Alternatively the fiber is produced from a fluoropolymer which is hydrophobic and oleophobic and therewith offers particularly good protection against water or cerumen. Examples of a suitable fluoropolymer are polyvinylidenefluoride (PVDF) and polytetrafluorethylene (PTFE), which is also known by the trade name Teflon®.

Fibers having a mean diameter of 50 nm to 10 μm may be produced by way of electrospinning. Fibers in the form of microfibers having a diameter of 1 μm and 3 μm may be easily produced, are robust and still allow a membrane to be produced which offers protection against water and dirt. Nanofibers having a diameter between 200 nm and 500 nm are particularly suitable for a very dense structure with very small pores which are particularly water and dirt-repellent.

Use of an optimally thin—and therewith noise-permeable—membrane having a thickness of less than 50 μm is particularly advantageous in particular for use of the membrane for covering an acoustic interface of the hearing aid, e.g. a noise exit opening on the receiver or noise admittance opening on the microphone. On the other hand, the impermeability to water increases as the thickness increases. A good balancing of the various requirements is possible in the range between 20 μm and 80 μm.

A membrane diameter between 2 mm and 10 mm is preferred, depending on the type of opening on the hearing aid that is to be covered.

A covering which is separate from the hearing aid or can be separated therefrom, having a membrane as described above, allows easy replacement of the membrane in the event of damage. Such a covering for a hearing aid also offers the option of fitting a hearing aid model with different membranes or of changing the type of covering. For this purpose it is provided that, in addition to the membrane itself, the covering also contains a holding frame which partially surrounds the membrane, and a fixing device for fixing the covering to the hearing aid.

A covering having a holding frame made from plastics material, into which the membrane is molded, may be produced particularly easily. By way of a fixing device with a click closure straightforward fixing of the covering to the hearing aid is possible despite the small size of a hearing aid.

A hearing aid having an embodiment of the membrane is protected against the penetration of water and dirt into the hearing aid.

The method for producing the membrane is based on the method known per se of electrospinning, wherein the non-woven structure resulting from the electrospinning is shaped in accordance with the opening of the hearing aid. This shaping can occur e.g. by way of punching or cutting. In further method steps the membrane can either be placed in the holding frame of the covering which can be fixed to the hearing aid or be fixed directly to the opening of the hearing aid.

Other features which are considered as characteristic for the invention are set forth in the appended claims.

Although the invention is illustrated and described herein as embodied in a membrane for covering an opening in a hearing aid and a method of making the membrane, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing an arrangement for electrospinning fibers using a target plate according to the invention;

FIG. 2 is an illustration showing an arrangement for electrospinning fibers having a target drum;

FIG. 3 is a plan view of a membrane made from PLLA microfibers having a diameter of 2 μm;

FIG. 4 is a cross-sectional view of the membrane according to FIG. 3;

FIG. 5 is a plan view of the membrane made from PLLA nanofibers having a diameter of 400 nm;

FIG. 6 is a cross-sectional view of the membrane according to FIG. 5;

FIG. 7 is a plan view of a covering having the membrane and a holding frame;

FIG. 8 is a cross-sectional view of the covering according to FIG. 7;

FIG. 9 is a sectional view showing a receiver housing having the membrane covering according to FIGS. 7 and 8;

FIG. 10 is an illustration showing a grid-like arrangement of a large number of membranes;

FIG. 11 is an illustration of a hearing aid having membrane coverings; and

FIG. 12 is a flow chart showing a method for producing a membrane for a hearing aid with the aid of electrospinning.

### DETAILED DESCRIPTION OF THE INVENTION

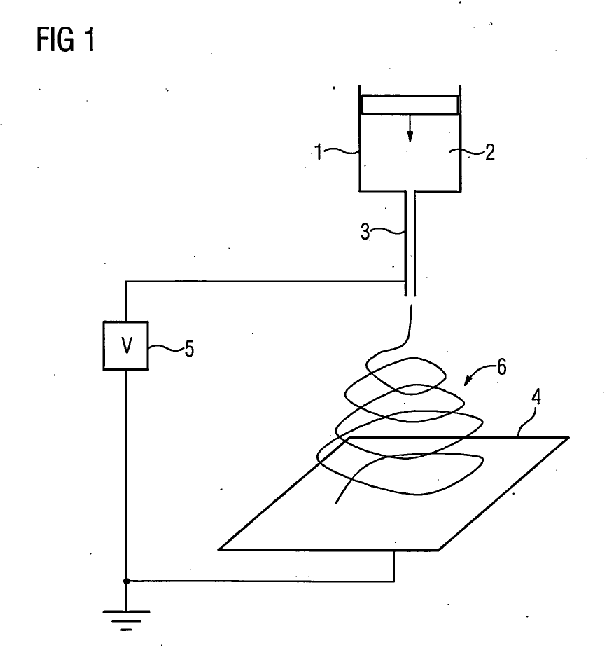

Referring now to the figures of the drawing in detail and first, particularly, to FIG. 1 thereof, there is shown a principle of an arrangement for electrospinning fibers. A molten or dissolved polymer 2 is located in a syringe 1 and this is pushed through the cannula 3 out of the syringe 1. The cannula 3 is directed toward a target plate 4. Both the cannula 3 and the target plate 4 are made from metal. A voltage is produced between the cannula 3 and the target plate 4 by a voltage source 5, with the voltage typically lying between 5 kV and 35 kV. The spacing between the cannula 3 and the target plate 4 can be 5 cm to 30 cm by way of example.

Due to an interplay between the surface tension of the liquid polymer 2 and the electrostatic attraction of the polymer 2 by the target plate the polymer forms what is known as a Taylor cone at the tip of the cannula 3, from the tip of which cone a thin, initially still liquid polymer filament 6 issues. The polymer filament 6 accelerates on the way to the target plate 4 and increasingly hardens until it finally accumulates on the target plate 4 as a thin solidified fiber. Due to the voltage drop from the tip of the cannula 3 and the target plate 4 the polymer filament 6 accelerates and during the course of the solidification process assumes an irregularly swirled shape.

A mat made from a non-woven structure of thin fibers forms on the target plate 4 as a result of this process. The fibers can have a diameter between 50 nm and 10 μm. This depends inter alia on the spacing between the cannula 3 and the target plate 4, the type of polymer, the shape of the liquefaction of the polymer and the applied voltage. This method and the connections between these production parameters and the resulting filaments are basically known per se.

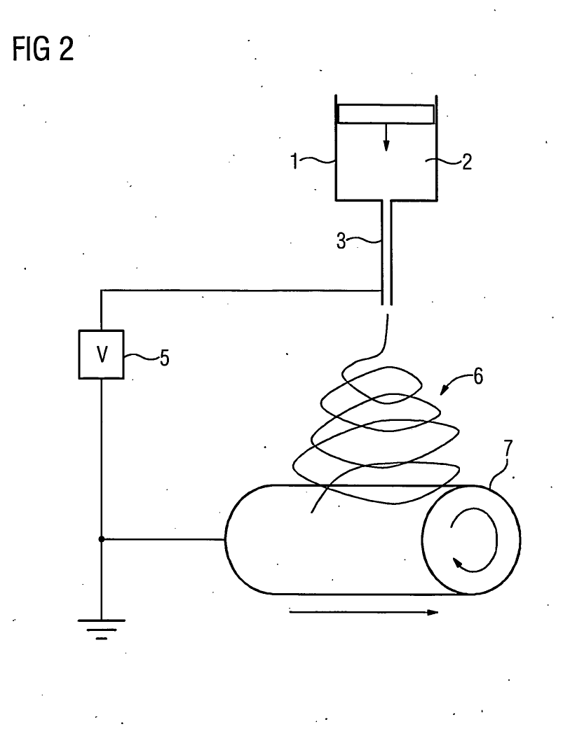

FIG. 2 shows a further arrangement for electrospinning and this differs from the arrangement shown in FIG. 1 in the type of target electrode. Instead of the target plate 4 a metal target drum 7 is arranged in FIG. 2 which can be rotated about its longitudinal axis and can be moved in the longitudinal direction. The properties of the fiber itself and of the fiber structure are influenced by such a movement during the production process. These movement parameters can therefore be taken into consideration within the framework of an iterative optimization process when adapting the woven material to the requirements.

By adapting the movement parameters the fibers can in particular be given a specific orientation. It is also possible, following the pass of the cylinder in one direction, to repeat the process of electrospinning on the same cylinder with a changed direction of movement in order to arrange fiber layers with different orientations one above the other in order to form an overall structure.

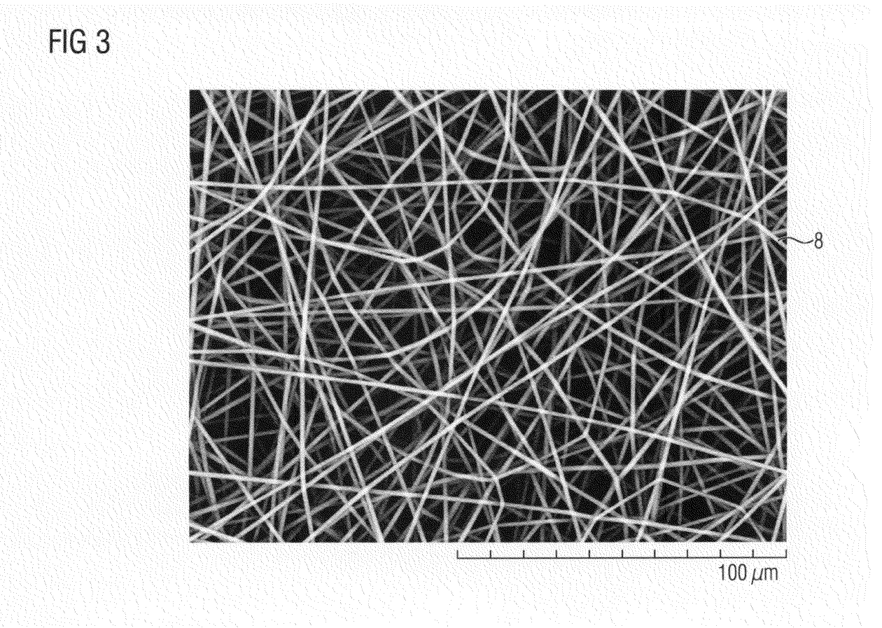

FIGS. 3 to 6 show in a plan view and a cross-section respectively two examples of non-woven structures of fibers 8 as a result of electrospinning. The fiber structures 8 are constructed in such a way that they fulfill certain requirements of a membrane for covering an opening in a hearing aid. Such membranes should be water, fat and/or dirt-repellent. They must also be sufficiently mechanically durable and easy to process. For covering sound openings the membrane must also be sound-permeable.

PET, PLA, PLLA and fluoropolymers such as PTFE, ePTFE and PVDF are suitable as polymers. The fibers 8 can have a mean diameter between 400 nm and 2 μm and be arranged to form a membrane thickness between 20 μm and 70 μm. The density of the structure can be 10% or less by way of example, i.e. the polymer volume is 10% or less of the total volume of the membrane. As the density increases and as the membrane thickness increases, the structure becomes increasingly impermeable to water, but simultaneously less permeable to sound. This demonstrates by way of example that the individual production and material parameters have to be balanced with respect to the requirements and coordinated in conjunction. This occurs within the framework of expert handling by way of a systematic, iterative adaptation process.

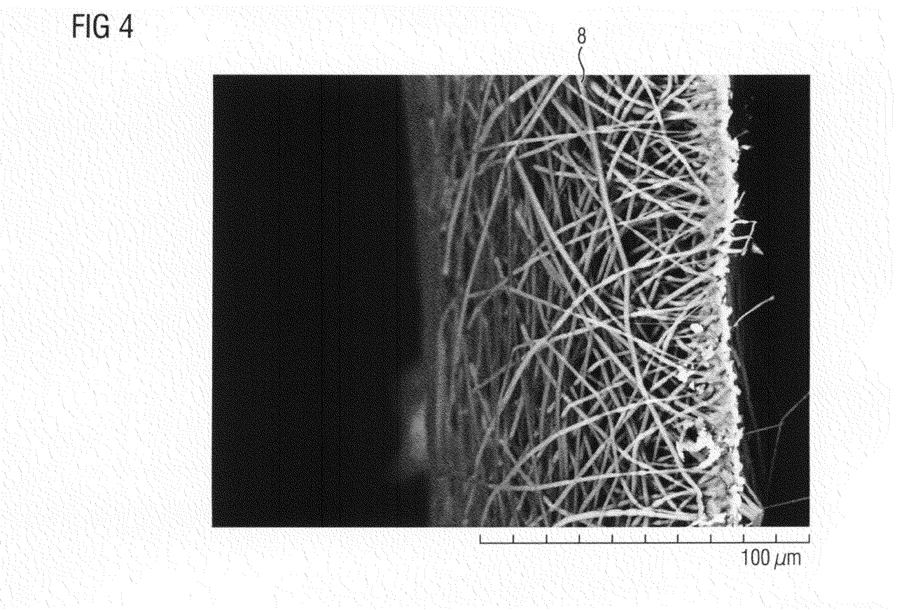

FIGS. 3 and 4 show in a plan view and a cross-sectional view respectively a membrane having a structure made from non-woven fibers 8 made of PLLA with a mean diameter of 2 μm and a thickness of 70 μm. Thinner membranes of this kind with a thickness of 20 μm are also conceivable.

With a membrane thickness of 60 μm to 70 μm the membrane withstands a water pressure of 20 mbar for more than 12 hours without water penetrating through the membrane. A reduction in the membrane thickness to 40 μm increases water permeability.

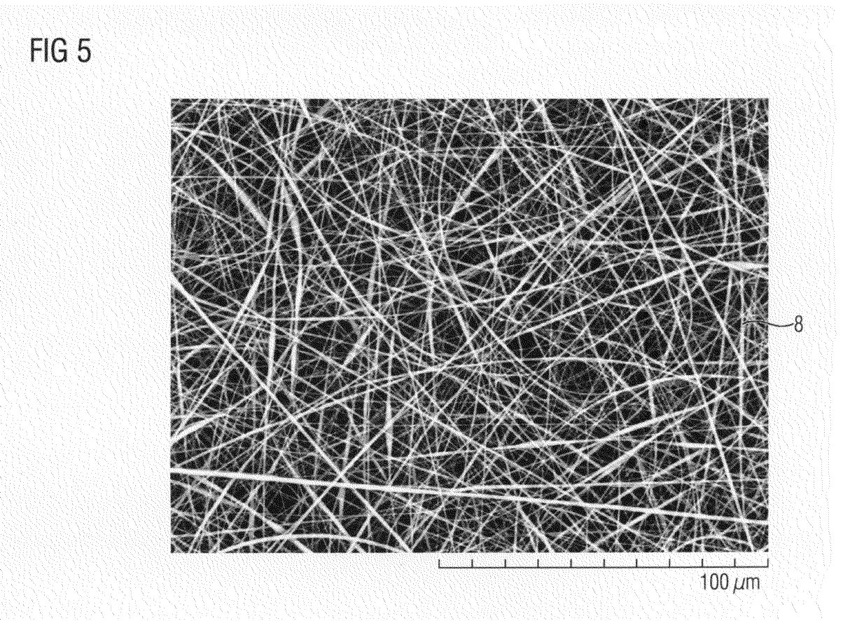

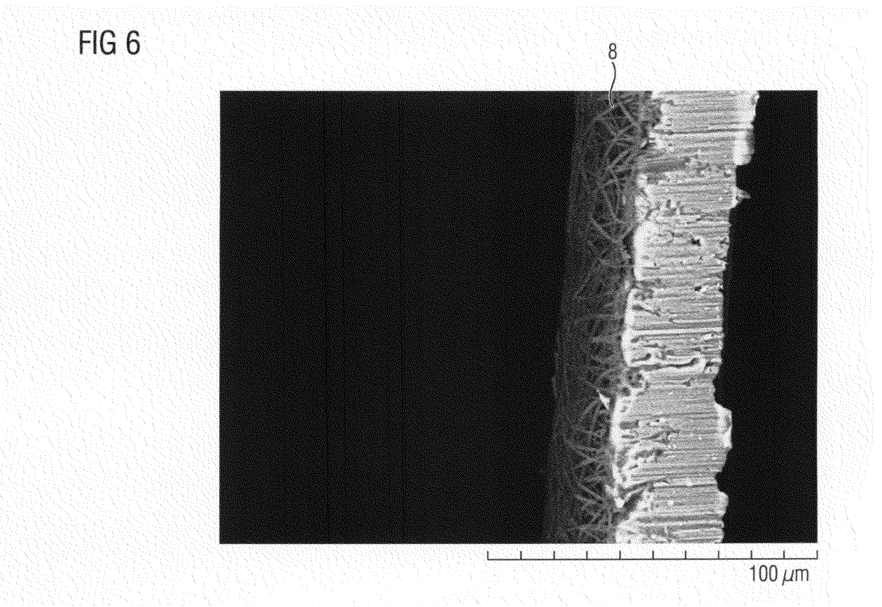

FIGS. 5 and 6 also show in a plan view and a cross-sectional view respectively a membrane which has been improved with respect to acoustic permeability, having a mean fiber diameter of 400 nm and an increased fiber density. As in the exemplary embodiment shown in FIGS. 3 and 4, the fibers 8 consist of the polymer PLLA.

With a membrane thickness of 20 μm this membrane withstands a pressure of about 10 mbar for 60 seconds before water slowly penetrates through the membrane.

It is possible to use polymer blends in order to combine their properties. The membrane can also be produced by an overlaying of fiber structures made from different polymers and different fiber properties. The individual fiber layers can also differ with respect to their fiber density, the respective thickness and the fiber structure. Therefore, a rough layer for example can strengthen the stability of the membrane and a thin and dense layer can increase the water tightness.

The following parameters can be adjusted to adapt the membrane for covering different openings:

water-repellent properties,
fat-repellent properties,
fiber diameter,
blend of fibers 8 made from different materials,
blend of fibers 8 having different fiber diameters,
use of oriented or non-oriented fibers 8,
a plurality of layers made from oriented fibers 8 having different orientations, e.g.
two layers with fibers 8 oriented orthogonally to each other,
size of the pores between the fibers 8,
subsequent hardening of the membrane, e.g. by tempering,
laser structuring of the membrane,
inclusion of bioactive materials in the fibers 8, e.g. antibacterial active ingredients,
concentric arrangement of fibers 8 made from two materials, e.g. what are known as core sheet-fibers, and
use of materials which are approved for medical use.

Basically, the membrane should be as thin as possible, e.g. less than 50 μm thick, but still be durable. Fluoropolymers can be used for fat and water-repellent properties. It should also be possible to easily connect the membrane to the hearing aid.

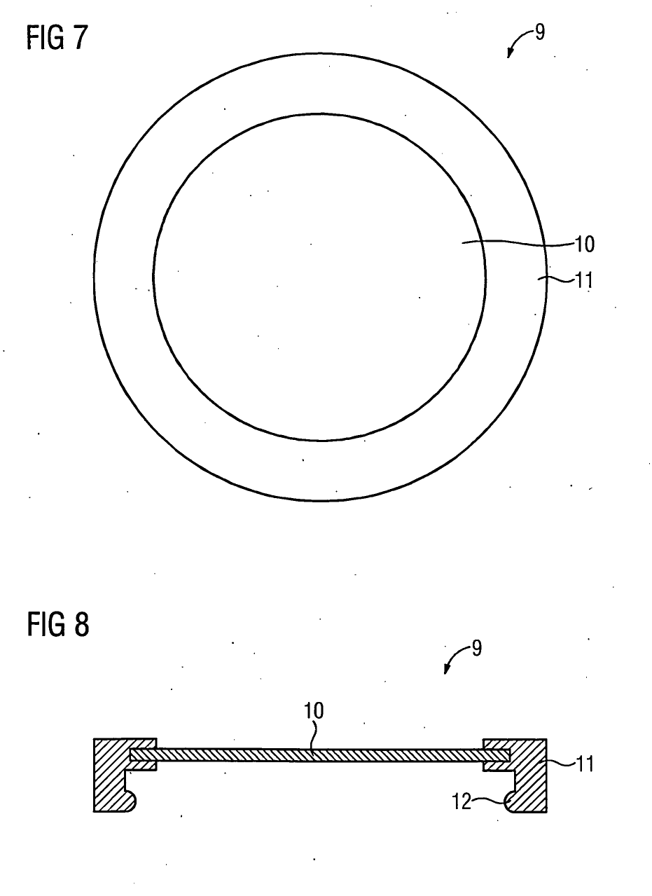

FIG. 7 shows in a plan view a covering 9 for an opening in a hearing aid. The covering 9 contains a round membrane 10 and a holding frame 11, which surrounds the membrane 10 in its entirety. In this exemplary embodiment the membrane 10 has a diameter of 5 mm. Membrane diameters between 2 mm and 10 mm are typically expedient for covering openings in a hearing aid. The holding frame 11 has a radial width of 1 mm.

The membrane 10 is round in this exemplary embodiment. Alternatively elliptical, rectangular and any other shapes are conceivable.

The membrane 10 is configured so as to be flat here but can also be bent in one direction, be spherically curved or be locally bulged. The shape of the membrane 10 can be determined by enclosure in the holding frame 11 or be predefined by a shaping as early as during electrospinning, e.g. by a corresponding shape of the target electrode.

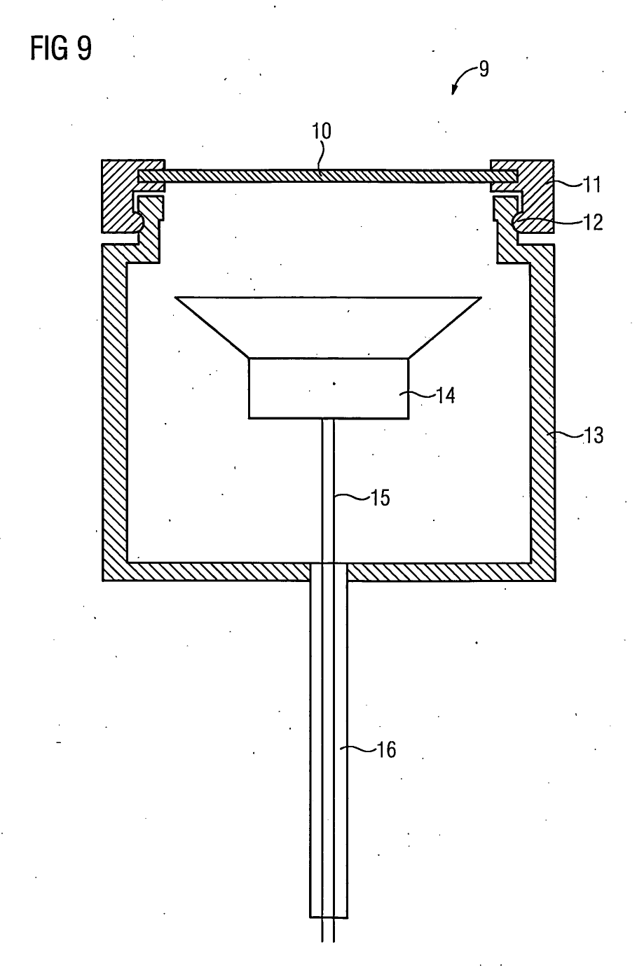

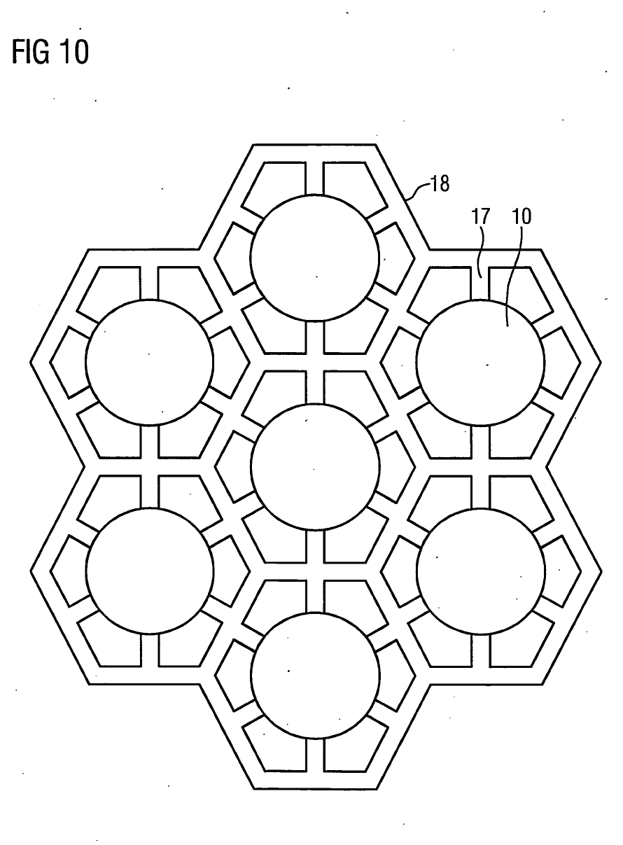

FIG. 8 shows a cross-sectional view of the covering 9 according to FIG. 7. In this view it can be seen that the membrane 10 is radially molded into the holding frame 11. The holding frame 11 contains a fixing device in the form of a click closure 12 whose mode of operation is illustrated in FIG. 9.

FIG. 9 schematically shows a receiver housing 13, on which the covering 9 according to FIGS. 7 and 8 is fixed with the aid of the click closure 12. The click closure 12 has a radially inwardly oriented molding which engages with interlocking fit in a corresponding counterpart in the receiver housing 13. In this exemplary embodiment the molding encircles the entire circumference of the holding frame 11. Alternatively the molding can also contain individual knobs at certain points.

The receiver housing 13 is configured for introduction into an auditory canal. The shape of the receiver housing 13 is therefore anatomically adapted, although this cannot be inferred from this schematic drawing. Located in the receiver housing 13 is a receiver 14 which is connected by an electrical wire 15 via a cable 16 leading out of the receiver housing 13 to the remaining part of the hearing aid, which is designed e.g. for an arrangement behind the auricle. The receiver 14 produces an acoustic signal as a function of an electrical signal via the electric wire 15, and the signal exits the receiver housing 13 through the membrane 10.

The covering 9 is attached in front of an opening of the receiver housing 13, so the membrane 10 seals the opening against the penetration of water and foreign particles, e.g. cerumen and dust. In this embodiment the membrane 10 is acoustically permeable, so the sound produced through the receiver 14 can exit the receiver housing 13.

FIG. 10 shows a grid-like arrangement of a large number of membranes 10. The membranes 10 are each connected by six plastic webs 17 arranged radially around the respective membranes 10 to a plastic grid 18. This form is suitable for easily transporting the membranes 10 and incorporating them in an automatic finishing process.

The shape of the membranes 10 following electrospinning is determined by laser ablation or by simple cutting or punching. The individual membranes 10 are then incorporated in the grid-like arrangement and connected to the plastic webs 17. Arranged in this form further details of the shape of the membranes 10 can be determined by a further laser ablation.

FIG. 10 shows only a detail of the grid-like arrangement which expands in all directions by repeating the illustrated pattern.

Instead of a grid-like arrangement of membranes, a linear arrangement of the membranes 10 one behind the other in a chain also allows simple further processing.

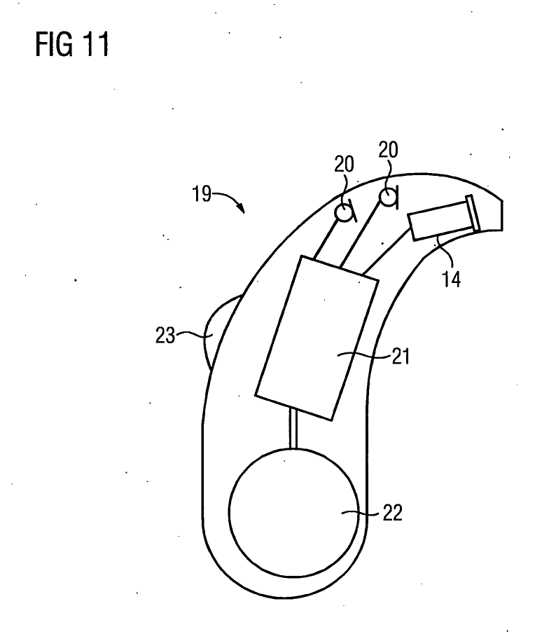

FIG. 11 schematically shows a hearing aid 19, which can be worn behind the ear, with two microphones 20, a signal processing unit 21, a battery compartment 22, an operating element 23 and a receiver 14. One opening respectively is provided in the housing of the hearing aid 19 for the microphones 20, the battery compartment 22, the operating element 23 and the receiver 14.

These openings are covered by different types of membranes 10 which are not shown in this schematic drawing. The membranes 10 are each produced by electrospinning, wherein the production parameters are adapted to the respective requirements of the membrane 10.

An opening is provided in the battery compartment which is used for ventilating the battery, which is usually dependent on a supply of air for operation. The membrane 10 attached in front of this opening must be particularly water-tight.

The operating element can be a switch element for selection of a hearing program or a volume control. The associated opening in the housing of the hearing aid 19 must be covered by a mechanically stabile and water-tight membrane 10 in this case. The membrane 10 does not have to be acoustically permeable, however.

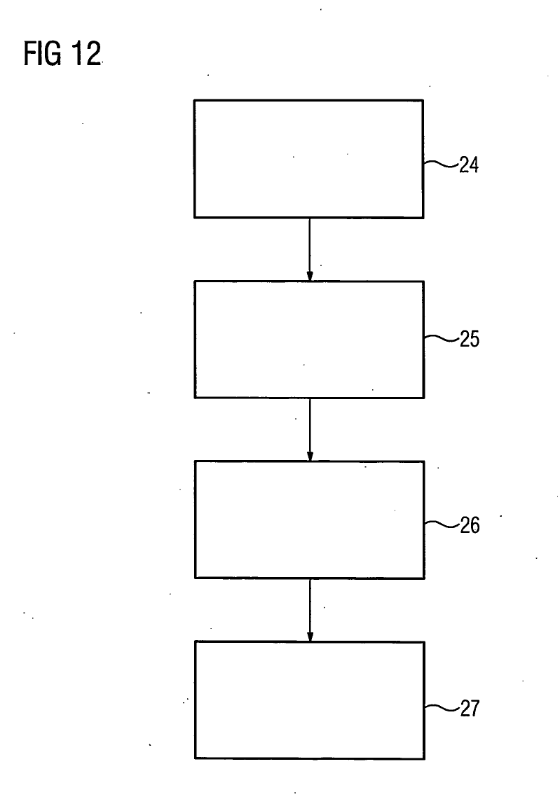

FIG. 12 shows a method for producing the membrane 10 for covering an opening of the hearing aid 19. In a first step 24 a non-woven structure is produced by electrospinning fibers 8. The process of electrospinning has already been described in more detail in connection with FIGS. 1 and 2. In the description relating to FIGS. 3 to 6 it has been described how the production parameters are systematically adapted to the requirements for covering openings on a hearing aid 19. In a second step 25 the membrane 10 is shaped from the non-woven structure of fibers 8 in accordance with the opening. The shaping can occur by way of laser ablation, cutting or punching.

In a further optional process step a large number of the membranes 10 is arranged to form a regular grid, as is shown in FIG. 10.

Finally the membrane 10 is attached to the hearing aid 19 for covering the opening. This takes place by way of example in two sub-steps, so the membrane 10 is firstly molded—as described in the context of FIGS. 7, 8 and 9—into a holding frame 11 in step 26 and then the resulting covering 9 is fixed with the aid of the click mechanism 12 to the hearing aid 19, step 27.

Although the invention has been illustrated and described in more detail by the exemplary embodiments, the invention is not limited by the disclosed examples and the person skilled in the art can derive other variations herefrom without departing from the scope of the invention.

1. A membrane for covering an opening in a hearing aid, the membrane comprising:
a non-woven structure produced by electrospinning fibers.

2. The membrane according to claim 1, wherein said non-woven structure is produced from a polylactic acid.

3. The membrane according to claim 1, wherein said non-woven structure is produced from a fluoropolymer.

4. The membrane according to claim 1, wherein said non-woven structure has fibers in a form of nanofibers with a diameter between 200 nm and 500 nm.

5. The membrane according to claim 1, wherein said non-woven structure has fibers in a form of microfibers with a diameter between 1 μm and 3 μm.

6. The membrane according to claim 1, wherein said non-woven structure has a membrane thickness of between 20 μm and 80 μm.

7. The membrane according to claim 1, wherein said non-woven structure has a membrane thickness of less than 50 μm.

8. The membrane according to claim 1, wherein said non-woven structure has a diameter between 2 mm and 10 mm.

9. A covering for an opening in a hearing aid, the covering comprising:
a membrane produced by electrospinning fibers into a non-woven structure;
a holding frame at least partially surrounding said membrane; and
a fixing device for fixing the covering to the hearing aid.

10. The covering according to claim 9, wherein said holding frame contains a plastic material into which said membrane is molded.

11. The covering according to claim 1, wherein said fixing device contains a click closure.

12. A hearing aid, comprising:
a hearing aid housing having an opening formed therein; and
a membrane produced by electrospinning fibers into a non-woven structure, said membrane covering said opening.

13. The hearing aid according to claim 12, wherein said opening is selected from the group consisting of a microphone opening, a receiver opening, an opening for a switch element and an opening for ventilating a battery compartment.

14. A method for producing a membrane for covering an opening of a hearing aid, which comprises the steps of:
electrospinning fibers to form a non-woven structure; and
forming the membrane from the non-woven structure in accordance with the opening.

15. The method according to claim 14, which further comprises producing the membrane from a polylactic acid.

16. The method according to claim 14, which further comprises producing the membrane from a fluoropolymer.

17. The method according to claim 14, which further comprises forming the membrane from fibers in a form of nanofibers with a diameter between 200 nm and 500 nm.

18. The method according to claim 14, which further comprises forming the membrane from fibers in a form of microfibers with a diameter between 1 μm and 3 μm.

19. The method according to claim 14, which further comprises forming the membrane with a membrane thickness of between 20 μm and 80 μm.

20. The method according to claim 14, which further comprises forming the membrane with a membrane thickness of less than 50 μm.

21. The method according to claim 14, which further comprises forming the membrane with a diameter between 2 mm and 10 mm.
